(19) United States
(12) Patent Application Publication
(10) Pub. No.: US 2005/0036076 A1
(43) Pub. Date: Feb. 17, 2005

(54) Projection television

(75) Inventors: Nam-gi Lee, Suwon city (KR); Weon-hee Lee, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/833,086

(22) Filed: Apr. 28, 2004

(30) Foreign Application Priority Data
Aug. 4, 2003 (KR) 2003-53833

(51) Int. Cl. H04N 5/64

(52) U.S. Cl. 348/787; 348/789

(57) ABSTRACT

A projection TV comprising a screen displaying an image wherein the screen is secured to the mask by selective rotation of a retainer which engages a hook on a backside of the mask. A bracket system provided inside of an edge part of the mask secure the retainer in rotation to engage the hook so that the retainer presses against the screen to retain the screen in the mask, simplifying a supporting structure for the screen.

### CROSS-REFERENCE TO RELATED APPLICATIONS

This application claims the benefit of Korean Patent Application No. 2003-53833, filed Aug. 4, 2003, in the Korean Intellectual Property Office, the disclosure of which is incorporated herein by reference.

### BACKGROUND OF THE INVENTION

1. Field of the Invention

The present invention relates to a projection television (TV), and more particularly, to a projection TV having a screen supported conveniently and stably by a mask using a screen supporting structure.

2. Description of the Related Art

In general, a projection TV displays images by projecting video beams onto a backside of a screen through a projector which forms the images.

The projection TV usually comprises a cathode ray tube (CRT) assembly projecting the video beams; a reflector reflecting the video beams projected from the CRT assembly; a screen displaying an image of the video beams reflected through the reflector; a mask provided in front of the screen and forming a front appearance; and a casing combined with the mask.

As shown in FIG. 1, a combination structure of a conventional projection TV is configured such that a screen 4 is supported by combining a plurality of screws 9 to a plurality bosses 8 integrally provided in the mask 2 to attach a bracket 6 to position the screen 4 behind the mask 2.

However, the mask 2 and the bracket 6 in the conventional projection TV have a fixed thickness, and therefore it is not easy to selectively support screens which are different in thickness, and to provide a strong support to the screen.

In addition, the plurality of screws 9 is required to fix the screen 4 in the mask 2, thereby decreasing work efficiency and productivity, and consequently increasing manufacturing cost.

### SUMMARY OF THE INVENTION

Accordingly, it is an aspect of the present invention to provide a projecting TV having a simplified supporting structure to selectively support screens which have different thicknesses.

The foregoing and/or other aspects of the present invention are also achieved by providing a projection TV comprising a screen displaying an image; a mask provided in front of the screen and comprising a hook formed on a backside of the mask; a bracket system provided inside of an edge part of the mask; and a screen supporting member rotatably provided in the bracket system and selectively combined to the hook of the mask by rotation to thereby press and support the screen.

According to an aspect of the present invention, the bracket system may further comprise a pair of side brackets combined to opposite ends of the screen supporting member, and retaining the screen supporting member.

According to an aspect of the present invention, each of the side brackets may comprise a guide groove in which the opposite ends of the screen supporting member are engaged.

According to an aspect of the present invention, the bracket system may further comprise at least one center bracket provided between the pair of side brackets, and supporting a center part of the screen supporting member.

According to an aspect of the present invention, the center bracket may be formed with a seating groove in which the center part of the screen supporting member is engaged.

According to an aspect of the present invention, the screen supporting member may further comprise a combining part combined to the bracket system, and a pressing part protruded from the combining part and pressing the screen.

According to an aspect of the present invention, the screen supporting member may comprise a wire structure.

Additional aspects and/or advantages of the invention will be set forth in part in the description which follows and, in part, will be obvious from the description, or may be learned by practice of the Invention.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a partial sectional view of a combination structure of a conventional projection TV;

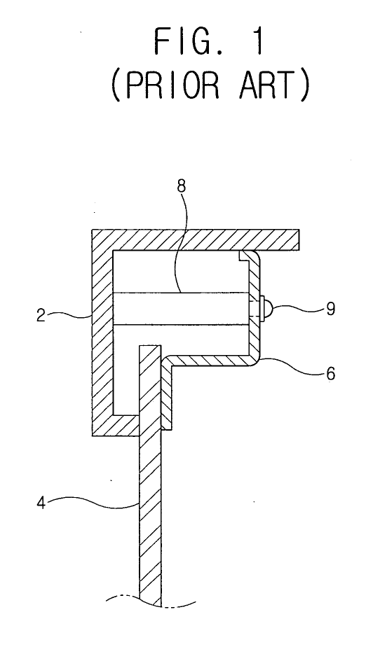

FIG. 2 is an exploded perspective view of a projection TV according to an embodiment of the present invention;

FIG. 3 is a combined perspective view of the projection TV in shown FIG. 2;

FIG. 4 is a perspective view of a bracket system and a screen supporting member of the projection TV according to the embodiment of the present invention;

FIG. 5 is a perspective view showing the screen supporting member in a separated state from a screen of the projection TV; and

FIG. 6 is a perspective view showing the screen supporting member in a combined state with the screen of the projection TV.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

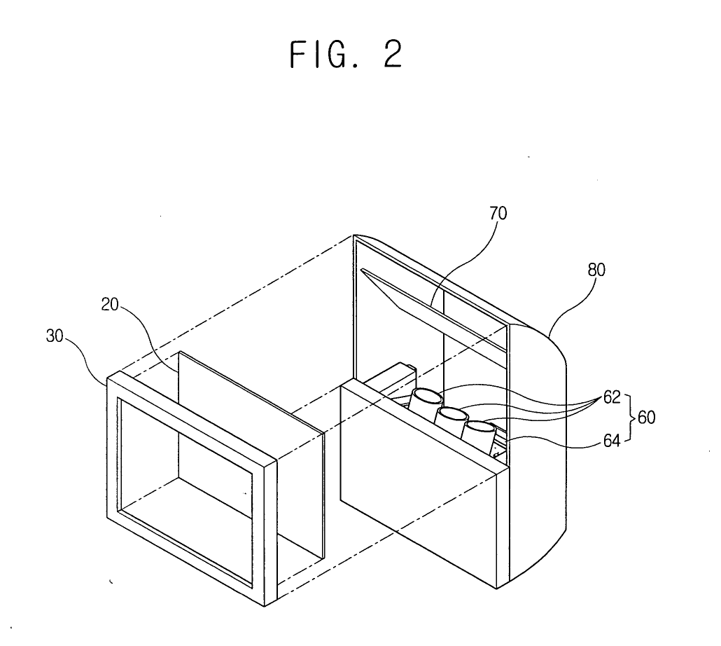

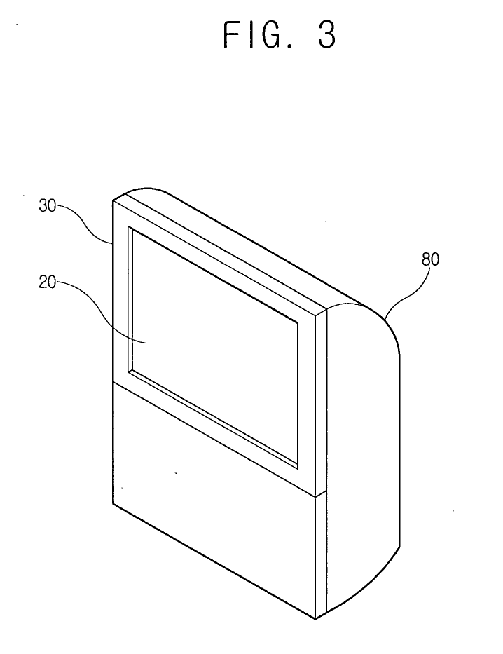

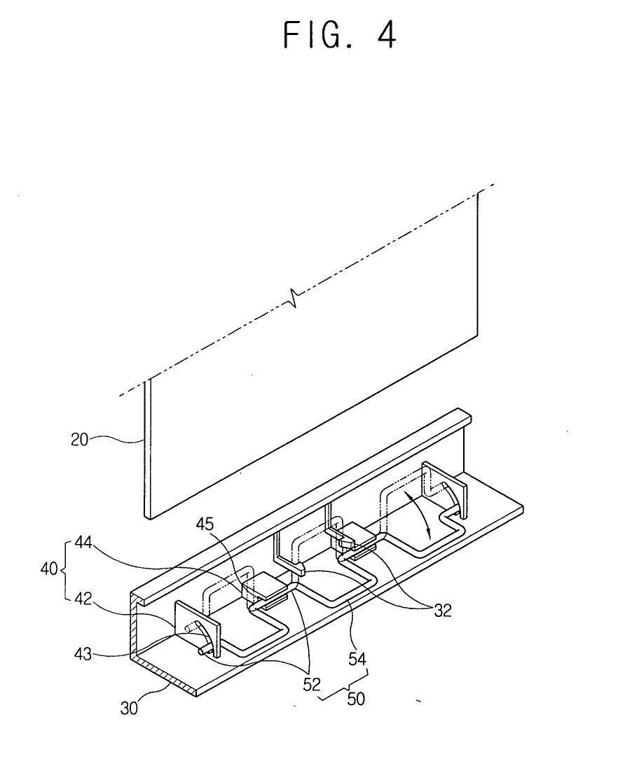

FIG. 2 is an exploded perspective view of a projection TV according to an embodiment of the present invention, FIG. 3 is a combined perspective view of the projection TV in FIG. 2, and FIGS. 4-6 are perspective views of a bracket and a screen supporting member of the projection TV according to an embodiment of the present invention.

As shown in FIGS. 2-6, the projection TV according to the embodiment of the present invention comprises a screen 20 displaying an image; a mask 30 provided in front of the screen 20, having a hook 32 in a rear portion of the mask 30; a bracket system 40 provided on an inner surface of the mask 30; a screen supporting member 50 rotatably disposed in the bracket system 40 and selectively combined to the hook 32, to thereby press and support the screen 20; a CRT assembly 60 projecting video beams; a reflector 70 reflecting the video beams, projected by the CRT assembly 60 onto a backside of the screen 20; and a casing 80 supporting the CRT assembly 60 and the reflector 70.

The screen 20 is of a plate shape having a predetermined thickness, and displays an image formed by the video beams reflected from the reflector 70 onto the backside of the screen 20. On an outside surface of the screen 20, an image forming sheet (not shown) such as a lenticular lens and a fresnel lens, and a protection sheet such as a sun screen are selectively provided.

The mask 30 is sized to cover the screen 20, and forms a front appearance of the projection TV by covering the outside part of the screen 20 at the edges of the mask 30.

The bracket system 40 comprises a pair of side brackets 42 supporting the screen supporting member 50 so that the screen supporting member 50 is rotable to a predetermined angle, and combined to opposite ends of the screen supporting member 50 to prevent the screen supporting member 50 from detachment; and at least one center bracket 44 provided between the pair of side brackets 42 and supporting a center part of the screen supporting member 50. The bracket system 40 can be variously changed in shape as long as the bracket system 40 supports the screen supporting member 50 to allow rotation of the screen supporting member to the predetermined angle.

In each of the pair of side brackets 42, a guide groove 43 accommodating a respective end of the screen supporting member 50 is provided. A structure of the guide groove 43 be changed as required to support rotation of the supporting member 50.

The center bracket 44 has a seating groove 45 securing the center part of the screen supporting member 50 to stably support the screen 20; and a structure of the seating groove 45 may be changed as required.

The screen supporting member 50 supports the screen 20 by pressing the screen 20, and thus any screen different in thickness can be easily combined to the mask 30. The screen supporting member 50 comprises a combining part 52 which engages the bracket system 40; and a pressing part 54 protruded from the combining part 52 and pressing the screen 20 when the screen supporting member 50 is rotated against the screen 20. The strength of the screen supporting member 50 is strong enough to press and support the screen 20, and a structure of the screen supporting member 50 is selectively changeable. The screen supporting member may be a wire structure having a simple shape and a strong pressing force.

The screen supporting member 50 may have a predetermined elasticity to be easily combined with the hook 32.

The casing 80 is provided to form rear and side appearances of the projection TV, and combined to the mask 30 by a combining means such as a screw (not shown). In a bottom inside part of the casing 80, the CRT assembly 60 projecting video beams is accommodated. The reflector 70 is inclined in an upper inside part of the casing 80 to reflect the video beams projected from the CRT assembly 80 to the screen 20. In a bottom side of the casing 80, a circuit board (not shown) is provided to control the CRT assembly 60 and any other necessary components.

The CRT assembly 60 comprises a plurality of CRTs 62 and a CRT frame 64 supporting the plurality of CRTs 62, and is engaged to a bottom part of the casing 80, at an angle to project the video beams to the reflector 20.

A plurality of brackets of the bracket system 40 and corresponding screen supporting members 50 may be suitably disposed around the periphery of the mask 30. A number and location of the bracket system 40 and the corresponding screen supporting members 50 can be changed as required.

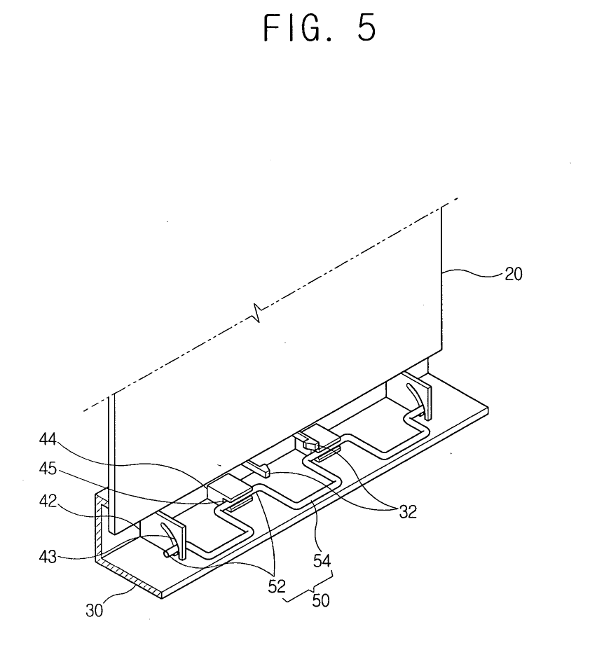

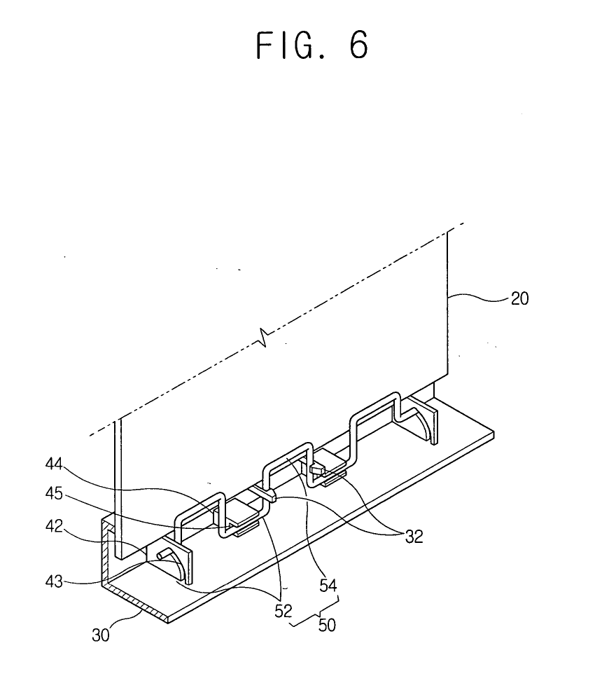

FIGS. 5 and 6 are exploded perspective views illustrating a screen and a mask of the projection TV according to the embodiment of the invention, in a separated state and in a combined state, respectively.

As shown in FIG. 5, the screen 20 is mounted on the mask 30 and the combining part 52 of the screen supporting member 50 is secured in the guide grooves 43 of the side brackets 42 and the seating groove 45 of the center bracket 44.

Then, the screen supporting member 50 is rotated about 90 degrees toward the screen 20 so that the screen 21 is pushed and supported by the pressing part 54 of the screen supporting member 50, to thereby fix the screen 20 firmly on the mask 30. Here, the screen supporting member 50 is engaged in the hook 32, and thus keeps pressing the screen 20.

A separating process of the screen 20, on the other hand, is simply accomplished by releasing the pressing part 54 of the screen supporting part 50 from the hook 32 and counter-rotating the screen supporting part 50.

As describe above, a supporting structure is simplified, thereby enhancing work efficiency, productivity, and maintenance capability, and thereby decreasing a cost of production and/or maintenance.

Also, the supporting structure has an advantage of being easily and conveniently adaptable for supporting screens different in thickness, such as for example, by making minor changes in a shape of the pressing part 54.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A projection TV comprising:
a screen which displays an image;
a mask provided in front of the screen and comprising a hook in a backside of the mask;
a bracket system provided on the backside of the mask and within an edge part of the mask; and
a screen supporting member rotatably provided in the bracket system and selectively combined to the hook of the mask by rotation to press and support the screen.

2. The projection TV according to claim 1, wherein the bracket system comprises a pair of side brackets combined to respective opposite ends of the screen supporting member, the pair of side brackets adapted to retain the screen supporting member.

3. The projection TV according to claim 2, wherein each of the side brackets comprises a guide groove in which a respective end of the screen supporting member engaged.

4. The projection TV according to claim 2, wherein the bracket system further comprises:
at least one center bracket provided between the pair of side brackets, and which supports a center part of the screen supporting member.

5. The projection TV according to claim 4, wherein the at least one center bracket is formed with a seating groove in which a center part of the screen supporting member is engaged.

6. The projection TV according to claim 3, wherein the bracket system further comprises:
at least one center bracket provided between the pair of side brackets, and which supports a center part of the screen supporting member.

7. The projection TV according to claim 6, wherein the at least one center bracket is formed with a seating groove in which a center part of the screen supporting member engaged.

8. The projection TV according to claim 1, wherein the screen supporting member comprises a combining part combined to the bracket system, and a pressing part protruded from the combining part and pressing the screen.

9. The projection TV according to claim 8, wherein the screen supporting member has a wire structure.

10. A projection TV comprising:
a casing which forms a rear and a side appearance of the projection TV;
a screen having a display surface which displays an image; and
a mask which retains and positions the screen relative to the casing, the mask comprising:
a first retainer provided on a backside of the mask, and
a second retainer mounted on the backside of the mask and which rotates about a first axis parallel to the display surface of the screen to engage the first retainer to secure the screen in the mask.

11. The projection TV according to claim 10, wherein the first retainer comprises a hook.

12. The projection TV according to claim 10, wherein:
the second retainer comprises a center portion disposed on the first axis, end portions disposed on a second axis offset from the first axis and a pressing portion offset from the first and second axes;
the center portion of the second retainer rotates about the first axis; and
the end portions translate relative to the display surface to engage the pressing portion with the screen.

13. The projection TV according to claim 12, wherein the mask further comprises:
a pair of end brackets which position the second retainer in the mask, each of the pair of end brackets engaging a respective one of the end portions of the second retainer and having a slot which permits the translation of the respective end portion relative to the display surface; and
at least one center bracket, disposed between the end brackets and in which the center portion of the second retainer is rotatably mounted.

14. The projection TV according to claim 13, wherein:
the first retainer comprises at least one hook which engages the pressing portion of the second retainer to retain the screen.

15. The projection TV according to claim 13, wherein the pair of end brackets position the screen relative to a portion of the mask periphery.

16. The projection TV according to claim 13, wherein the at least one hook positions the screen relative to a portion of the mask periphery.

17. A connector to connect a screen with a mask of a TV comprising the screen, the connector comprising:
a first retainer provided on a backside of the mask, and
a second retainer that is mounted on the backside of the mask and rotates about a first axis parallel to the display surface of the screen to engage the first retainer to secure the screen in the mask.

18. The projection TV according to claim 17, further comprising:
a pair of end brackets which position the second retainer in the mask, each of the pair of end brackets engaging a respective one of the end portions of the second retainer and having a slot which permits the translation of the respective end portion relative to the display surface; and
at least one center bracket, disposed between the end brackets and in which the center portion of the second retainer is rotatably mounted.
